(19) United States
(12) Patent Application Publication
(10) Pub. No.: US 2025/0105438 A1
(43) Pub. Date: Mar. 27, 2025

(54) RECHARGEABLE BATTERY

(71) Applicant: Samsung SDI Co., Ltd., Yongin-si (KR)

(72) Inventors: Kwangjo Cheong, Yongin-si (KR); Minyoung Jang, Yongin-si (KR); Hyun Cho, Yongin-si (KR)

(73) Assignee: Samsung SDI Co., Ltd., Yongin-si (KR)

(21) Appl. No.: 18/894,646

(22) Filed: Sep. 24, 2024

(30) Foreign Application Priority Data
Sep. 26, 2023 (KR) 10-2023-0129507

(51) Int. Cl. H01M 50/342; H01M 50/105; H01M 50/133; H01M 50/148

(52) U.S. Cl. CPC H01M 50/3425; H01M 50/105; H01M 50/133; H01M 50/148

(57) ABSTRACT

A rechargeable battery according to the present disclosure includes: an electrode assembly; a pouch case that includes a first receiving portion surrounding a part of the electrode assembly, a second receiving portion that is coupled with the first receiving portion while surrounding the rest of the electrode assembly, and a penetration portion penetrating one or more of the first receiving portion and second receiving portion, and that receives the electrode assembly; and a venting member that is provided in the penetration portion, and is opened when an internal pressure reaches a threshold pressure.

### CROSS-REFERENCE TO RELATED APPLICATIONS

This present application claims priority to and the benefit under 35 U.S.C. § 119 (a)-(d) of Korean Patent Application No. 10-2023-0129507, filed on Sep. 26, 2023, in the Korean Intellectual Property Office, the entire disclosure of which is incorporated herein by reference.

### FIELD

The present disclosure relates to a rechargeable battery.

### BACKGROUND

Unlike a primary battery, which is incapable of being recharged, a rechargeable battery can be repeatedly charged and discharged. In the case of a low-capacity battery with one electrode assembly packaged in pack form, the battery may be used in a small portable electronic device such as a mobile phone and/or a camcorder, and in the case of a large capacity battery with several tens of electrode assemblies connected, the battery may be used as a power source for a driving motor of an electric scooter, a hybrid vehicle, and/or an electric device.

The rechargeable battery can be manufactured in various shapes. Among these, a pouch battery can include an electrode assembly that is formed by interposing a separator, which is an insulator, between a positive electrode plate and a negative electrode plate and can include a thin flexible pouch embedded with the electrode assembly.

In general, with the lighter weight of a portable wireless device such as a video camera, a portable phone, a portable computer, and/or a digital camera, and with the development and higher functionality of an electric vehicle, a rechargeable battery used as a power source may need to be small while having high energy density and excellent charging and discharging characteristics.

### SUMMARY

The present disclosure is intended to overcome some problems described herein and to provide a rechargeable battery that can discharge a gas generated inside a pouch case.

However, the technical object that the present disclosure may solve is not limited only to the problems described herein, and other problems not mentioned can be clearly understood by a person of ordinary skill in the art from the description of the present disclosure.

A rechargeable battery according to an embodiment to solve the above-stated technical object (e.g., to overcome some problems described herein) includes an electrode assembly, a pouch case that receives the electrode assembly, and a venting member that is provided in a penetration portion and is opened when an internal pressure reaches a threshold pressure.

The rechargeable battery according to an embodiment includes: an electrode assembly; a pouch case that receives the electrode assembly and that includes a first receiving portion surrounding a part of the electrode assembly, a second receiving portion that is coupled with the first receiving portion while surrounding a remaining part of the electrode assembly that is not surrounded by the first receiving portion, and a penetration portion penetrating one or more of the first receiving portion and second receiving portion; and a venting member that is provided in the penetration portion, and is configured to open when an internal pressure of the pouch case reaches a threshold pressure.

The penetration portion may penetrate each of the first receiving portion and the second receiving portion, the venting member may comprise more than one venting member, and the venting member may be provided in the penetration portion of each of the first receiving portion and second receiving portion.

The venting member may include: a cut portion including a cut pattern; an extension portion extending to the outside (e.g., an outside region) from a circumference surface (e.g., a circumferential surface) of the cut portion; a seating portion that is disposed along a circumference surface of the extension portion, that has a relatively low height with respect to the extension portion (e.g., a height lower than the extension portion), and that is seated on an edge of the penetration portion in the pouch case; and an adhesive portion that is interposed between the seating portion and the penetration portion and that adheres the seating portion and the penetration portion to each other.

The pouch case may further include an inlet portion that is introduced along the edge of the penetration portion to a depth corresponding to a thickness of the seating portion of the venting member, and into which the seating portion is seated.

The cut pattern may include: a first cut line formed in the shape of a straight line; and a second cut line formed in the shape of the alphabet letter V shape and is positioned at both ends of the first cut line.

The cut pattern may be formed in the shape selected from any one of the alphabet letter I and the alphabet letter H.

The adhesive portion may be a double-sided adhesive tape.

The adhesive portion may be coated with an acryl-based adhesive.

The venting member may further include a close and seal portion that is disposed along a boundary between the extension portion and the pouch case, and that is configured to close and seal between the venting member and the pouch case.

The venting member may be disposed at a central portion of the pouch case.

The venting member may be disposed in a portion of the pouch case adjacent to an edge of the pouch case.

A thickness of the venting member may be formed to correspond to a thickness of the pouch case.

An externally exposed surface of the venting member may be disposed on the same plane as an external surface of the pouch case.

According to the present disclosure, the rechargeable battery may include the venting member. Therefore, in cases in which gas is generated due to decomposition of electrolyte inside the pouch case, the gas can be effectively discharged to the outside. Accordingly, safety can be improved by preventing electric short or explosion due to excessive shape deformation.

According to some aspects of the present disclosure, a method of manufacturing a rechargeable battery includes: providing an electrode assembly in a pouch case that receives the electrode assembly, the pouch case including: a first receiving portion surrounding a part of the electrode assembly, a second receiving portion coupled with the first receiving portion while surrounding a remaining part of the electrode assembly that is not surrounded by the first receiving portion, and a penetration portion penetrating one or more of the first receiving portion and the second receiving portion; and providing a venting member in the penetration portion, wherein the venting member is configured to open when an internal pressure of the pouch case reaches a threshold pressure.

The method may further include forming the venting member with a first thickness corresponding to a second thickness of the pouch case.

### BRIEF DESCRIPTION OF THE DRAWINGS

The drawings accompanying this specification illustrate example embodiments of the present disclosure, and serve to further convey the technical idea of the present disclosure together with the detailed description of the present disclosure. Therefore, the present disclosure should not be interpreted as limited to the matters illustrated in the drawings.

FIG. 1 is an exploded perspective view of a rechargeable battery, according to some embodiments.

FIG. 2 is an exploded perspective view of a venting member in a state of being installed in a second receiving portion of a pouch case.

FIG. 3 is a perspective view of the venting member of FIG. 2.

FIG. 4 is a top plan view of an exemplary variation of a cut pattern of the venting member of FIG. 2.

FIG. 5 is a top plan view of another exemplary variation of the cut pattern.

FIG. 6 is a cross-sectional view of an installation process of the venting member to a penetration portion of the pouch case.

FIG. 7 is a cross-sectional view of a state in which the venting member is installed in the penetration portion of the pouch case.

FIG. 8 is a top plan view that shows a state in which the venting member is installed to a central portion of the pouch case.

FIG. 9 is a top plan view of a state in which the venting member is installed in a portion adjacent to a first substrate tab and a second substrate tab at an edge of the pouch case.

FIG. 10 is a top plan view of a state in which the venting member is installed opposite to the first substrate tab and the second substrate tab at an edge of the pouch case.

### DETAILED DESCRIPTION

Hereinafter, example embodiments of the present disclosure will be described in detail with reference to the accompanying drawings. The terms or words used in this specification and claims should not be construed as being limited to conventional or dictionary meanings, and should be interpreted as meanings and concepts consistent with the technical idea of the present disclosure based on the principle that the inventors may appropriately define the concept of a term to describe the present techniques in the most suitable and/or appropriate way. Therefore, embodiments described in the present specification and the configurations shown in the drawings may only be preferred embodiments of the present disclosure, as an example, and may not represent all the technical ideas and/or spirit of the present disclosure. Therefore, it should be understood that various equivalents and modifications may be substituted for them at the time of filing the present application.

In addition, when used in this specification, “comprise/include” and/or “comprising/including” specifies the presence of the mentioned shape, number, step, operation, member, element, and/or groups thereof, and does not exclude the presence or addition of one or more other shapes, numbers, movements, members, elements and/or groups.

In addition, to aid understanding of the disclosure, the accompanying drawings may not be drawn to actual scale, but the dimensions of some components may be exaggerated. Further, the same reference number may refer to the same element in the drawings.

The statement that two objects of comparison are “the same” means “substantially the same”. Therefore, substantial identity may include a deviation that is considered low in the industry, for example, a deviation of less than 5%. In addition, uniformity of a parameter in a given region may mean uniformity from an average perspective.

Although terms, first, second, and the like, are used to describe various configuration elements, these elements are of course not limited by these terms. These terms are only used to distinguish one component from another component, and unless specifically stated to the contrary, the first component may also be the second component.

Throughout the specification, unless otherwise stated, each component may be singular or plural.

The placement of any component on “upper portion (or lower portion)” of a component or “top (or bottom)” of a component not only means that any component is placed in contact with the top (or bottom) of the component but also means that other components may be interposed between the component and any component placed on (or under) the component.

In addition, when a component is described as “on,” “connected to,” or “coupled to” another component, the components may be directly connected or linked to each other, but it should be understood that other components may be “interposed” between each component, or that each component may be “connected,” “coupled,” or “linked” through other components.

As used in this specification, the term “and/or” includes any and all combinations of one or more of the associated listed items. Further, the use of “may” when describing embodiments of the present disclosure refers to “one or more embodiments of the present disclosure.”

Expressions such as “one or more” and “one or more” preceding a list of elements modify the entire list of elements and do not modify individual elements in the list.

The expression “A and/or B” throughout the specification may mean A, B, or A and B, unless specifically stated to the contrary, and the expression “C to D”, may mean that it is higher than C and lower than D unless specifically stated to the contrary.

When a syntax such as “at least one selected from A, B and C”, “at least one selected from A, B or C”, “at least one selected from A, B and C group” and “at least one selected from A, B and C” is used to specify a list of elements A, B, and C, the syntax may refer to any and all suitable combinations.

The term “use” may be considered synonymous with the term “utilize.”

As used in this specification, “substantially,” “approximately,” and similar terms are used as terms of approximation rather than terms of degree, and this is to consider the inherent variation in measured or calculated values that a person of ordinary skill in the relevant technical field would recognize.

Although the terms first, second, third, and the like may be used in this specification to describe various elements, components, regions, layers and/or sections, these elements, components, regions, layers and/or sections should not be limited by these terms. This term is used to distinguish one element, component, region, drawing layer or cross-section from another element, component, region, drawing layer or cross-section. Accordingly, a first element, component, region, layer, or section discussed below may be named a second element, component, region, layer or section without departing from the teachings of the example embodiments.

For simplicity of description, spatial relative terms such as “beneath,” “below,” “lower,” “above,” “upper,” and the like may be used to describe the relationship between one element or feature and another element or feature(s) as shown in the drawing. The spatially relative position will be understood to encompass different directions of the device in use or operation in addition to the direction depicted in the figures. For example, when the drawing device is flipped, an element described as “below” or “bottom” another element is understood to be “on” or “above” another element. Therefore, the term “below” may encompass both up and down directions.

The terms used in this specification are intended to describe embodiments of the present disclosure and are not intended to limit the present disclosure.

As discussed herein, a rechargeable battery used as a power source may need to be small while having high energy density and excellent charging and discharging characteristics.

However, while the rechargeable battery may have the merits mentioned above, when abnormal operation conditions such as internal short circuit, overcharge, and/or high temperature exposure occur during operation, an internal electrolyte solution is decomposed and high-pressure gas is generated, which can cause deformation of the rechargeable battery and can shorten the lifespan. In particular, in the case of the rechargeable battery, when swelling occurs, it may lead to serious problems such as explosion or ignition, and therefore it is important to ensure stability.

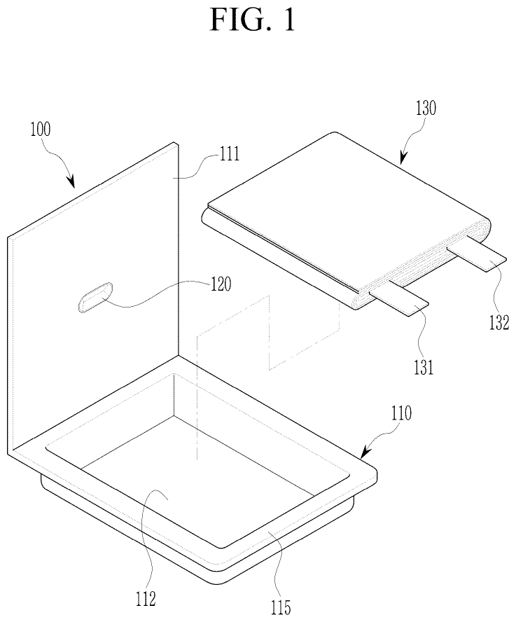

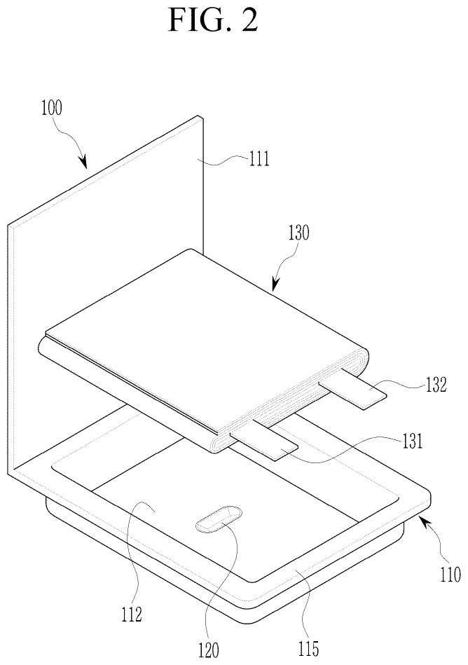

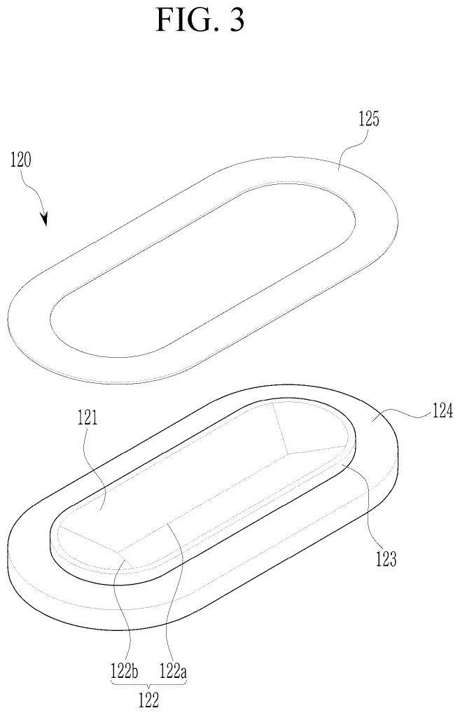

FIG. 1 is an exploded perspective view of a rechargeable battery according to some embodiments. FIG. 2 is an exploded perspective view of a venting member in a state of being installed in a second receiving portion of a pouch case. FIG. 3 is a perspective view of the venting member of FIG. 2.

As shown in FIG. 1 to FIG. 3, a rechargeable battery 100 may include an electrode assembly 130, a pouch case 110, and a venting member 120.

The electrode assembly 130 may include a first electrode plate, a second electrode plate, and a separator. A first substrate tab 131 may extend outward from the first electrode plate, and a second substrate tab 132 may extend outward from the second electrode plate.

The electrode assembly 130 may be formed by spirally winding or stacking a laminate including a first electrode plate, a second electrode plate, and a separator. For example, the electrode assembly 130 may be a repeatedly wound jelly-roll type.

Alternatively, the electrode assembly 130 may be provided in a plurality of electrode assemblies, and the plurality of electrode assemblies 130 may be of a stacked type arranged to be stacked in multiple layers. A detailed description of the electrode assembly 130 as described above will be omitted for simplicity.

The pouch case 110 may receive the electrode assembly 130. The electrode assembly 130 may be received in the pouch case 110 together with an electrolyte solution.

When the pressure inside the pouch case 110 exceeds a certain level, a portion of the venting member 120 is cut open and gas can be discharged. The venting member 120 may be installed in the pouch case 110, and is opened when the internal pressure of the pouch case 110 reaches a threshold pressure.

Therefore, when gas is generated due to decomposition of electrolyte inside the pouch case 110, the rechargeable battery 100 may effectively discharge the gas to the outside. Accordingly, safety can be improved by preventing electric short circuit or explosion due to excessive shape deformation.

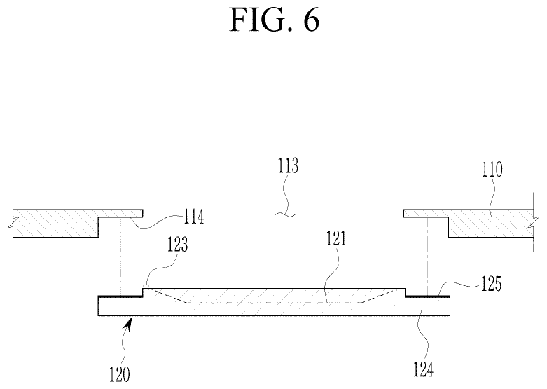

Meanwhile, the pouch case 110 described above may include, for example, a first receiving portion 111, a second receiving portion 112, and a penetration portion 113 (referring to FIG. 6).

The first receiving portion 111 may surround a part of the electrode assembly 130. The first receiving portion 111 may have, for example, a plate shape.

A portion of the second receiving portion 112 may be recessed to a certain depth for the electrode assembly to be inserted into, may surround the remaining portion of the electrode assembly 130 (e.g., the portion that is not surrounded by the first receiving portion), and may be combined with the first receiving portion 111. Here, the disclosure is not limited to only a portion of the second receiving portion 112 being recessed to a certain depth, and it may also be possible for a portion of the first receiving portion 111 to be recessed to a certain depth to surround a portion of the electrode assembly 130.

The penetration portion 113 (e.g., as shown in FIG. 6) penetrates at least one of the first receiving portion 111 and the second receiving portion 112 of the pouch case 110, and the venting member 120 may be installed in and/or provided in the penetration portion. The penetration portion 113 may be penetrated with a size corresponding to the venting member 120.

In the manufacturing method of the pouch case 110 as described above, for example, the first receiving portion 111 and the second receiving portion 112 of a (single) plate may be bent to face each other, and then one side may be pressed or drawn. The electrode assembly 130 may be received in the second receiving portion 112. A sealing portion 115 may be formed on an exterior circumference surface of the second receiving portion 112, and the sealing portion 115 may be sealed through thermal fusion and the like (e.g., to the first receiving portion 111), while the electrode assembly 130 is received in the second receiving portion 112.

Meanwhile, although it is not shown in the drawing, the penetration portion 113 may penetrate each of the first receiving portion 111 and the second receiving portion 112. In addition, the venting member 120 may be installed (e.g., provided) in the penetration portion 113 of each of or either of the first receiving portion 111 and the second receiving portion 112. That is, there may be two venting members 120, and it may be possible for each of the two venting members 120 to be installed on one side and/or the other side of the pouch case 110.

Accordingly, although any one venting member 120 may not be opened at the threshold pressure, the remaining venting member(s) 120 may be opened.

The above-described venting member 120 may include, for example, a cut portion 121, an extension portion 123, a seating portion 124, and an adhesive portion 125.

The cut portion 121 may include a cut pattern 122. The cut portion 121 may have a predetermined thickness. A portion of the cut portion 121 may have a cut pattern 122 of a specific shape. The cut pattern 122 may be disposed along a length direction of the cut portion 121.

The extension portion 123 may extend outward from the circumferential surface of the cut portion 121. When the venting member 120 is installed in the pouch case 110, the extension portion 123 may contact an edge of the penetration portion 113 of the pouch case 110.

The seating portion 124 is disposed along the circumferential surface of the extension portion 123, has a relatively low height with respect to the extension portion 123, and may be seated on an edge of the penetration portion 113 in the pouch case 110.

The adhesive portion 125 may be disposed between the seating portion 124 and the penetration portion 113, and may bond the seating portion 124 and the penetration portion 113 to each other. The adhesive portion 125 may be a double-sided adhesive tape. Alternatively, the adhesive portion 125 may be coated with an acryl-based adhesive.

The above-described venting member 120 may be strongly (e.g., securely) coupled to the penetration portion 113 of the pouch case 110 by the adhesive portion 125. At least a portion of the venting member 120 may be installed in the penetration portion 113 as a result of the coupling.

Hereinafter, the cut pattern 122 of the venting member 120 and the pouch case 110 will be described in more detail.

The cut pattern 122 may include, for example, a first cut line 122a and a second cut line 122b.

The first cut line 122a may be formed in the shape of a straight line.

The second cut line 122b may have the alphabet letter V shape and may be disposed (e.g., positioned) on and/or at both ends of the first cut line 122a. That is, the second cut line 122b may be a shape that gradually spreads from each end of the first cut line 122a. The second cut line may include two or more cut lines.

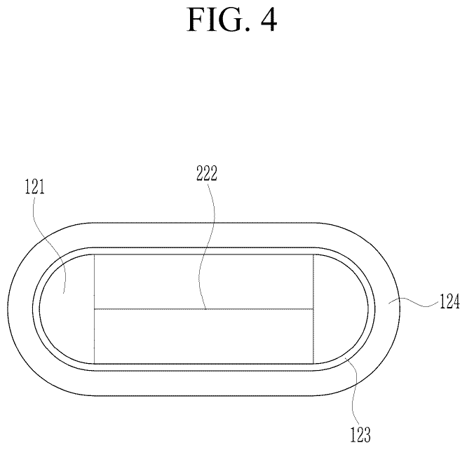

As an exemplary variation, the cut pattern 122 may be any one selected from the alphabet letter I shape and H shape. Specifically, as shown in FIG. 4, the cut pattern 222 may have the alphabet letter H shape and may be disposed along a length direction of the cut portion 121.

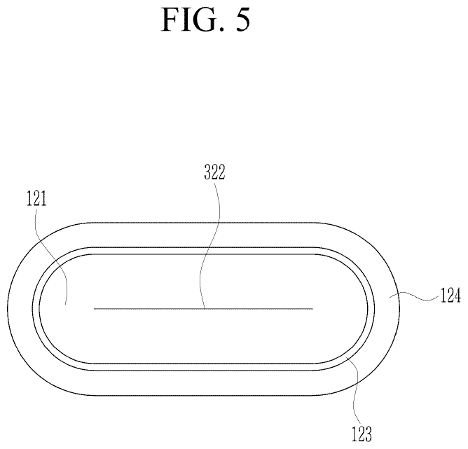

Alternatively, as shown in FIG. 5, the cut pattern 322 has the alphabet letter I shape, and both ends of the cut pattern 322 may be connected to the edges of the cut portion 121, respectively. Accordingly, when the internal pressure of the pouch case 110 reaches the threshold pressure, the cut portion 121 is torn from the cut pattern 122 and quickly opened.

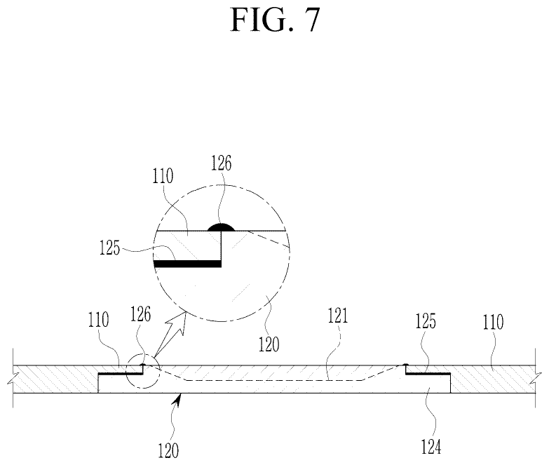

FIG. 6 is a cross-sectional view of an installation process of the venting member to the penetration portion of the pouch case. FIG. 7 is a cross-sectional view of a state in which the venting member is installed in the penetration portion of the pouch case.

Referring to FIG. 6 and FIG. 7, the pouch case 110 may further include an inlet portion 114.

The inlet portion 114 may be introduced along the edge of the penetration portion 113 to a depth corresponding to a thickness of the seating portion 124 of the venting member 120. The aforementioned seating portion 124 may be seated in the inlet portion 114. The venting member 120 may be stably installed in the pouch case 110 by the inlet portion 114.

Meanwhile, the venting member 120 may further include a close and seal portion 126.

The close and seal portion 126 may be disposed along a boundary between the extension portion 123 and the pouch case 110, and may close and seal (e.g., may be configured to close and seal) between the venting member 120 and the pouch case 110. The close and seal portion 126 may be formed by a thermal fusion method, in some embodiments.

That is, the close and seal portion 126 may be a portion of each of the extension portion 123 and the pouch case 110 fused by heat and then hardened.

The close and seal portion 126 can not only improve the bonding strength between the venting member 120 and the pouch case 110, but can also prevent foreign substances from inflow between the venting member 120 and the pouch case 110.

Meanwhile, a thickness of the venting member 120 may correspond to a thickness of the pouch case 110. In addition, a surface of the venting member 120, exposed to the outside (e.g., an externally exposed surface) may be disposed on the same plane as the external surface of the pouch case 110. Accordingly, the venting member 120 may be disposed so as not to protrude toward the outside or inside of the pouch case 110.

Therefore, the electrode assembly 130 and the venting member 120 may be prevented from interfering with each other. In addition, interference between an external member of the pouch case 110 and the venting member 120 can be prevented.

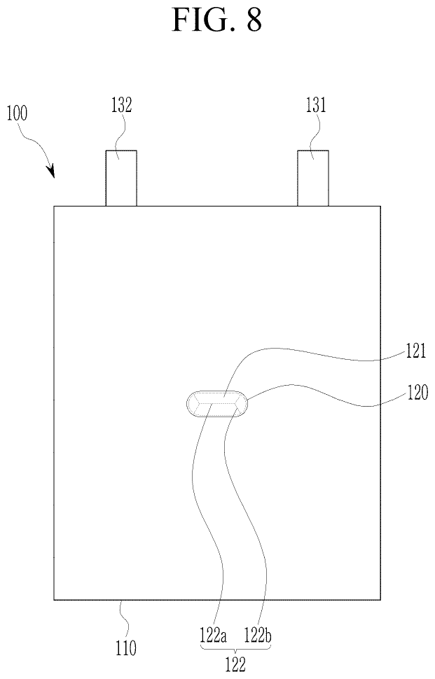

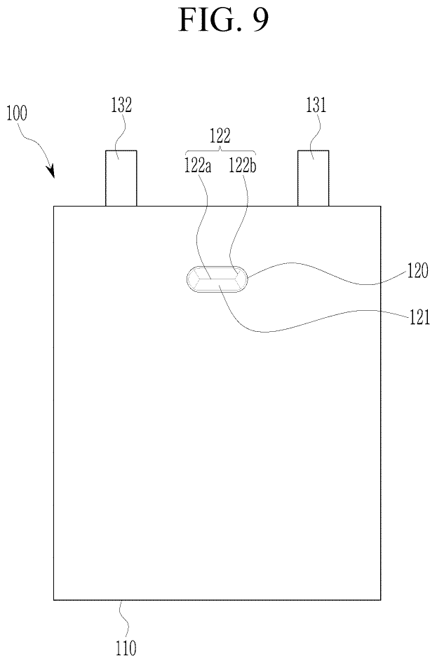

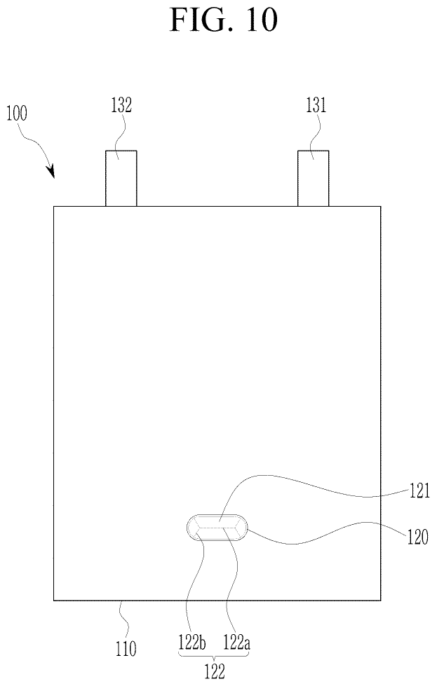

FIG. 8 is a top plan view that shows a state in which the venting member is installed to a central portion of the pouch case. FIG. 9 is a top plan view of a state in which the venting member is installed in a portion adjacent to a first substrate tab and a second substrate tab at an edge of the pouch case. FIG. 10 is a top plan view of a state in which the venting member is installed opposite to the first substrate tab and the second substrate tab at an edge of the pouch case.

Referring to FIG. 8, the venting member 120 may be disposed in a central portion of the pouch case 110. Alternatively or additionally, referring to FIG. 9 and FIG. 10, the venting member 120 may be disposed in a portion adjacent to the edge of the pouch case 110.

However, in instances when swelling occurs in the rechargeable battery 100, it is common for the central portion of the pouch case 110 to swell. Therefore, it may be advantageous for the venting member 120 to be disposed in the central portion of the pouch case 110 to discharge gas inside the pouch case 110 (e.g., as shown in FIG. 8).

As described above, the rechargeable battery 100 according to the present disclosure may include the venting member 120. Therefore, when gas is generated such as due to decomposition of electrolyte inside the pouch case 110, the gas can be effectively discharged to the outside. Accordingly, safety can be improved by preventing electric short or explosion due to excessive shape deformation (e.g., of the rechargeable battery 100).

According to some embodiments, there is provided a method of manufacturing a rechargeable battery, including: providing an electrode assembly in a pouch case that receives the electrode assembly, the pouch case including: a first receiving portion surrounding a part of the electrode assembly, a second receiving portion coupled with the first receiving portion while surrounding a remaining part of the electrode assembly that is not surrounded by the first receiving portion, and a penetration portion penetrating one or more of the first receiving portion and the second receiving portion; and providing a venting member in the penetration portion, wherein the venting member is configured to open when an internal pressure of the pouch case reaches a threshold pressure.

According to some embodiments, the venting member includes: a cut portion including a cut pattern; an extension portion extending to an outside region from a circumferential surface of the cut portion; a seating portion disposed along the circumferential surface of the extension portion, wherein the seating portion has a height lower than the extension portion and is seated on an edge of the penetration portion in the pouch case; and an adhesive portion interposed between the seating portion and the penetration portion that adheres the seating portion and the penetration portion to each other.

According to some embodiments, the venting member is provided at a central portion of the pouch case.

According to some embodiments, the method may include forming the venting member with a first thickness corresponding to a second thickness of the pouch case.

The accompanying drawings and the detailed description of the present disclosure as described above are only exemplary embodiments of the present disclosure, which are used for the purpose of describing the present disclosure but are not used to limit the meanings or the scope of the present disclosure described in the claims. Accordingly, those skilled in the art will understand that various modifications and other equivalent embodiments are possible therefrom. Therefore, the true technical protection scope of the present disclosure will be defined by the technical spirit of the accompanying claims.

### DESCRIPTION OF SYMBOLS

| | |
|---|---|
| 100: rechargeable battery | 110: pouch case |
| 111: first receiving portion | 112: second receiving portion |
| 113: penetration portion | 114: inlet portion |
| 120: venting member | 121: cut portion |
| 122: cut pattern | 122a: first cut line |
| 122b: second cut line | 123: extension portion |
| 124: seating portion | 125: adhesive portion |
| 126: close and seal portion | 130: electrode assembly |

1. A rechargeable battery comprising:
an electrode assembly;
a pouch case that receives the electrode assembly, the pouch case including:
a first receiving portion surrounding a part of the electrode assembly,
a second receiving portion coupled with the first receiving portion while surrounding a remaining part of the electrode assembly that is not surrounded by the first receiving portion, and
a penetration portion penetrating one or more of the first receiving portion and the second receiving portion; and
a venting member provided in the penetration portion, wherein the venting member is configured to open when an internal pressure of the pouch case reaches a threshold pressure.

2. The rechargeable battery of claim 1, wherein:
the venting member comprises:
a cut portion including a cut pattern;
an extension portion extending to an outside region from a circumferential surface of the cut portion;
a seating portion disposed along a circumferential surface of the extension portion, wherein the seating portion has a height lower than the extension portion and is seated on an edge of the penetration portion in the pouch case; and
an adhesive portion interposed between the seating portion and the penetration portion that adheres the seating portion and the penetration portion to each other.

3. The rechargeable battery of claim 2, wherein:
the pouch case further comprises an inlet portion that is introduced along the edge of the penetration portion to a depth corresponding to a thickness of the seating portion of the venting member, and into which the seating portion is seated.

4. The rechargeable battery of claim 2, wherein:
the cut pattern comprises:
a first cut line formed in the shape of a straight line; and
a second cut line formed in the shape of the alphabet letter V shape and positioned at both ends of the first cut line.

5. The rechargeable battery of claim 2, wherein:
the cut pattern is formed in the shape selected from any one of the alphabet letter I and the alphabet letter H.

6. The rechargeable battery of claim 2, wherein:
the adhesive portion is a double-sided adhesive tape.

7. The rechargeable battery of claim 2, wherein:
the adhesive portion is coated with an acryl-based adhesive.

8. The rechargeable battery of claim 2, wherein:
the venting member further comprises a close and seal portion that is disposed along a boundary between the extension portion and the pouch case, wherein the close and seal portion is configured to close and seal between the venting member and the pouch case.

9. The rechargeable battery of claim 1, wherein:
the penetration portion penetrates each of the first receiving portion and the second receiving portion,
the venting member comprises more than one venting member, and
the venting member is provided in the penetration portion of each of the first receiving portion and second receiving portion.

10. The rechargeable battery of claim 1, wherein:
the venting member is disposed at a central portion of the pouch case.

11. The rechargeable battery of claim 1, wherein:
the venting member is disposed in a portion of the pouch case adjacent to an edge of the pouch case.

12. The rechargeable battery of claim 1, wherein:
a thickness of the venting member is formed to correspond to a thickness of the pouch case.

13. The rechargeable battery of claim 1, wherein:
an externally exposed surface of the venting member is disposed on a same plane as an external surface of the pouch case.

14. A method of manufacturing a rechargeable battery, the method comprising:
providing an electrode assembly in a pouch case that receives the electrode assembly, the pouch case including:
a first receiving portion surrounding a part of the electrode assembly,
a second receiving portion coupled with the first receiving portion while surrounding a remaining part of the electrode assembly that is not surrounded by the first receiving portion, and
a penetration portion penetrating one or more of the first receiving portion and the second receiving portion; and
providing a venting member in the penetration portion, wherein the venting member is configured to open when an internal pressure of the pouch case reaches a threshold pressure.

15. The method of claim 14, wherein the venting member comprises:
a cut portion including a cut pattern;
an extension portion extending to an outside region from a circumferential surface of the cut portion;
a seating portion disposed along the circumferential surface of the extension portion, wherein the seating portion has a height lower than the extension portion and is seated on an edge of the penetration portion in the pouch case; and
an adhesive portion interposed between the seating portion and the penetration portion that adheres the seating portion and the penetration portion to each other.

16. The method of claim 14, wherein the venting member is provided at a central portion of the pouch case.

17. The method of claim 14, further comprising forming the venting member with a first thickness corresponding to a second thickness of the pouch case.
